(19) United States
(12) Patent Application Publication
(10) Pub. No.: US 2011/0080849 A1
(43) Pub. Date: Apr. 7, 2011

(54) APPARATUS AND METHOD FOR FLEXIBLE EQUIVALENT PUBLIC LAND MOBILE NETWORK MANAGEMENT IN PORTABLE TERMINAL

(75) Inventor: Kwang-Hae CHOI, Seongnam-si (KR)

(73) Assignee: SAMSUNG ELECTRONICS CO. LTD., Suwon-si (KR)

(21) Appl. No.: 12/896,079

(22) Filed: Oct. 1, 2010

(30) Foreign Application Priority Data
Oct. 7, 2009 (KR) 10-2009-0094953

(51) Int. Cl. H04L 12/28

(52) U.S. Cl. 370/254

(57) ABSTRACT

A portable terminal and a method for management of an equivalent Public Land Mobile Network (PLMN) in a portable terminal is provided. The method includes obtaining equivalent PLMN information from a network, classifying at least one equivalent PLMN by using a tag of the at least one equivalent PLMN included in the equivalent PLMN information, adding the at least one equivalent PLMN included in the one equivalent PLMN information to an equivalent PLMN list together with the tag, and deleting the equivalent PLMN if an equivalent PLMN, which includes a tag value corresponding to a process for obtaining the equivalent PLMN information and which is included in the list and is not included in the equivalent PLMN information, is stored in the equivalent PLMN list.

### PRIORITY

This application claims the benefit under 35 U.S.C. §119(a) of a Korean patent application filed in the Korean Intellectual Property Office on Oct. 7, 2009 and assigned Serial No. 10-2009-0094953, the entire disclosure of which is hereby incorporated by reference.

### BACKGROUND OF THE INVENTION

1. Field of the Invention

The present invention relates to a portable terminal. More particularly, the present invention relates to an apparatus and method for flexibly managing an equivalent Public Land Mobile Network (PLMN) in a portable terminal.

2. Description of the Related Art

Global System for Mobile communication (GSM) is a digital mobile telephony system classified as a 2^{nd} Generation (2G) cellular system, and is widely used in Europe and other countries. A General Packet Radio Service (GPRS) developed based on the GSM is a more evolved packet-based mobile communication service. The GPRS has been evolved into a 3^{rd} Generation (3G) mobile communication system, more particularly, a Universal Mobile Telecommunication System (UMTS), for providing high-speed high-quality voice and multimedia services and is now being evolved into High Speed Downlink Packet Access (HSDPA), High Speed Uplink Packet Access (HSUPA), High Speed Packet Access+(HSPA+), Long Term Revolution (LTE), and the like.

Although the UMTS is based on the GSM communication standard, the UMTS uses a Wideband Code Division Multiple Access (WCDMA) technique to provide a service for transmitting packet-based text, digitalized voice or video and multimedia data at a speed above 2 Mbps to users of mobile phones or computers regardless of locations of the users. The UMTS uses a concept of a virtual access as a packet switching type access using a packet protocol such as an Internal Protocol (IP), and is always accessible to any node in a network.

The mobile communication technique has been evolved from the 2G cellular system, more particularly, the GSM/GPRS, to the 3G mobile communication system, more particularly, the UMTS. With the development of such a communication system, several network service providers have appeared, merged, or disappeared. Network service providers well-known worldwide have devised a method for providing a selection priority by assigning priorities to different networks or a method for assigning the same priority.

A Public Land Mobile Network (PLMN) is used to identify networks of mobile communication service providers. Accordingly, a terminal assigns priorities to a plurality of PLMNs, to access a network corresponding to a PLMN having a top priority among accessible networks in a network access process. Recently, the concept of an equivalent PLMN for assigning the same priority is used so that a plurality of service providers of each country are related with another PLMN according to a new business relation. The equivalent PLMN is delivered from the network to the terminal after a registration process is performed on a circuit network or a packet network, and thereafter is utilized when network reselection is performed by a user terminal.

A portable terminal performs Location Updating-Accept (LUA) and Routing Area Update, Accept (RUA) to deliver the equivalent PLMN, and thereafter replaces an equivalent PLMN list. In this case, a final equivalent PLMN list may differ depending on an order of the LUA and the RUA. For example, when a network service provider intentionally determines that an LUA of a PLMN Z indicates PLMNs A and B and an RUA thereof indicates PLMNs B and C, if the LUA and the RUA are performed in that order, the equivalent PLMN list includes the PLMNs B and C. However, if the RUA and the LUA are performed in that order, the equivalent PLMN list includes the PLMNs A and B. As a result, there is a problem in that portable terminals existing in the same area have different equivalent PLMN lists.

Therefore, a need exists for an apparatus and method for providing the same equivalent PLMN list in portable terminals existing in the same area.

### SUMMARY OF THE INVENTION

An aspect of the present invention is to address at least the above-mentioned problems and/or disadvantages and to provide at least the advantages described below. Accordingly, an aspect of the present invention is to provide an apparatus and method for allowing portable terminals existing in the same area to have the same equivalent Public Land Mobile Network (PLMN) list.

Another aspect of the present invention is to provide an apparatus and method for managing an equivalent PLMN list for each process in a portable terminal.

Still another aspect of the present invention is to provide an apparatus and method for automatically deleting an equivalent PLMN according to a tag value of the equivalent PLMN in a portable terminal.

In accordance with an aspect of the present invention, a method for operating a portable terminal is provided. The method includes obtaining equivalent PLMN information from a network, classifying at least one equivalent PLMN by using a tag of the at least one equivalent PLMN included in the equivalent PLMN information, adding the at least one equivalent PLMN included in the one equivalent PLMN information to an equivalent PLMN list together with the tag, and deleting the equivalent PLMN if an equivalent PLMN, which has a tag value corresponding to a process for obtaining the equivalent PLMN information and which is included in the list and is not included in the equivalent PLMN information, is stored in the equivalent PLMN list.

In accordance with another aspect of the present invention, a portable terminal apparatus is provided. The apparatus includes a controller for obtaining equivalent PLMN information from a network and for classifying at least one equivalent PLMN by using a tag of the at least one equivalent PLMN included in the equivalent PLMN information, and a storage unit for storing an equivalent PLMN list under the control of the controller, wherein the controller adds the at least one equivalent PLMN included in the one equivalent PLMN information to an equivalent PLMN list together with the tag, and deletes the equivalent PLMN if an equivalent PLMN, which has a tag value corresponding to a process for obtaining the equivalent PLMN information and which is included in the list and is not included in the equivalent PLMN information, is stored in the equivalent PLMN list.

In according with still another aspect of the present invention, a method for managing equivalent Public Land Mobile Network (PLMN) information in a portable terminal is provided. The method including obtaining equivalent PLMN information by at least one of a Location Updating-Accept (LUA) process and a Routing Area Update, Accept (RUA) process, classifying at least one equivalent PLMN by using a tag of the at least one equivalent PLMN included in the equivalent PLMN information, adding the at least one equivalent PLMN included in the one equivalent PLMN information to an equivalent PLMN list together with the tag, and if the equivalent PLMN information is obtained through the LUA process, determining an equivalent PLMN to be deleted among the remaining PLMNs other than equivalent PLMNs including a tag value Routing Area (RA), and if the equivalent PLMN information is obtained through the RUA process, determining the equivalent PLMN to be deleted among the remaining PLMNs other than equivalent PLMNs including a tag value Location Area (LA).

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a flowchart illustrating a process of operating a portable terminal according to an exemplary embodiment of the present invention; and

FIG. 2 is a block diagram illustrating a portable terminal according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention are provided for purposes of illustration only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

Exemplary embodiments of the present invention provide a method for allowing portable terminals existing in the same area to have the same equivalent Public Land Mobile Network (PLMN) list by subdividing the equivalent PLMN list. In the following description, the portable terminal includes, a cellular phone, a Personal Communication System (PCS), a Personal Digital Assistant (PDA), an International Mobile Telecommunication-2000 (IMT-2000) terminal, a net-book, and the like.

For more precise management of the equivalent PLMN, the exemplary embodiments of the present invention add a tag for indicating a valid area to equivalent PLMNs included in a message transmitted and received during a Location Updating-Accept (LUA) and Routing Update, Accept (RUA) process to determine a valid duration of each PLMN. Examples of a value of the tag added to the equivalent PLMN may include a Location Area (LA), a Routing Area (RA), a PLMN, and the like, and is managed according to each tag value as described below.

A tag value determined to the LA implies that a corresponding equivalent PLMN depends on only the LUA process. That is, the equivalent PLMN of the tag value LA is not deleted even if the RUA process is performed, and is deleted only by a new LUA process. For example, when a PLMN_A[LA] and a PLMN_B[LA] are received through the LUA process, even if a PLMN_C[RA] and a PLMN_D[RA] are received through the RUA process afterwards, the PLMN_A[LA] and the PLMN_B[LA] are not deleted. However, if the PLMN_A[LA] and a PLMN_D[LA] are received through the LUA process, the PLMN_B[LA] is deleted and the PLMN_D[LA] is added.

A tag value determined to the RA implies that a corresponding equivalent PLMN depends on only the RUA process. That is, the equivalent PLMN of the tag value RA is not deleted even if the LUA process is performed, and is deleted only by a new RUA process. For example, when a PLMN_A[RA] and a PLMN_B[RA] are received through the RUA process, even if a PLMN_C[LA] and a PLMN_D[LA] are received through the LUA process afterwards, the PLMN_A[RA] and the PLMN_B[RA] are not deleted. However, if the PLMN_A[RA] and a PLMN_D[RA] are received through the RUA process, the PLMN_B[RA] is deleted and the PLMN_D[RA] is added.

A tag value determined to the PLMN implies that a corresponding PLMN is maintained as an equivalent PLMN irrespective of the LUA process and the RUA process. That is, the equivalent PLMN of the tag value PLMN is not deleted even if it is not received through the LUA process or the RUA process. Therefore, the tag value PLMN is used to avoid resource waste resulted from repetitive transmission of the same equivalent PLMN in the LUA process or the RUA process. For example, when a PLMN_A[PLMN] and a PLMN_B[PLMN] are received through the LUA process or the RUA process, even if the PLMN_B[PLMN] and a PLMN_C[PLMN] are received afterwards through the LUA process or the RUA process, the PLMN_A[PLMN] is not deleted, and the equivalent PLMN list includes the PLMN_A[PLMN], the PLMN_B[PLMN], and the PLMN_C[PLMN].

The tag values not only provide a criterion for classifying the equivalent PLMN as described above but also define a time of deleting the equivalent PLMN. That is, when an area defined by the tag value is changed as the portable terminal moves, the equivalent PLMN having that tag value is deleted. For example, an equivalent PLMN having a tag value LA is deleted when a registered location area is changed. In addition, an equivalent PLMN having a tag value RA is deleted when a registered routing area is changed, and an equivalent PLMN having a tag value PLMN is deleted when a registered PLMN is changed.

Among the above described exemplary tag values, the tag value LA and the tag value RA may be included in a portable terminal, and the tag value PLMN may be additionally used for effective management of the equivalent PLMN list in a portable terminal.

Hereinafter, an operation and structure of a portable terminal for managing the above described equivalent PLMN will be described in detail below.

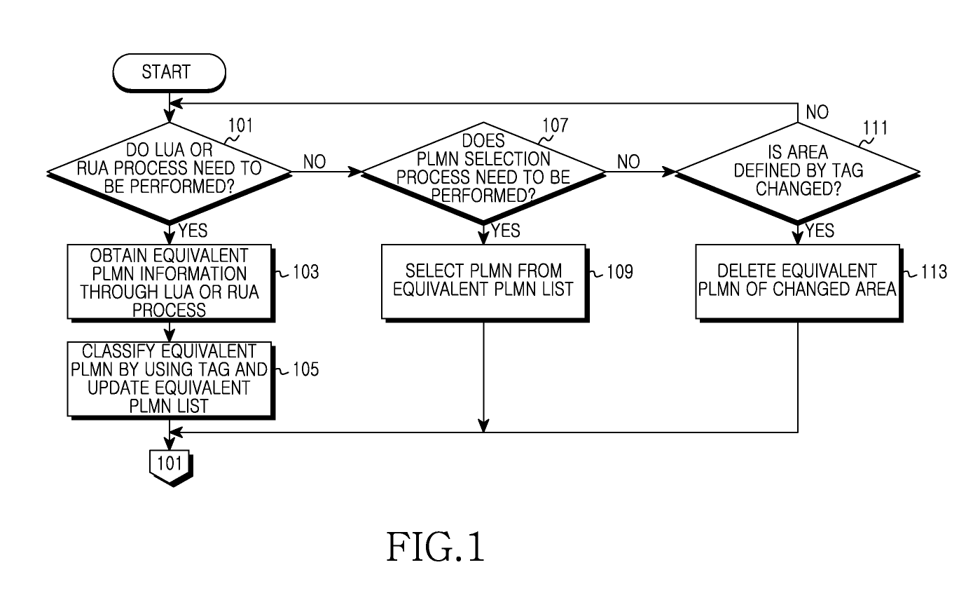

FIG. 1 is a flowchart illustrating a process for operating a portable terminal according to an exemplary embodiment of the present invention.

Referring to FIG. 1, the portable terminal determines whether an LUA process or an RUA process needs to be performed in step 101. For example, the LUA process and the RUA process are periodically performed according to a specific time interval.

If it is determined in step 101 that there is a need to perform the LUA process or the RUA process, the portable terminal performs the LUA process or the RUA process, and obtains an equivalent PLMN from a network through the LUA process or the RUA process in the step 103. That is, the portable terminal transmits a message for requesting Location Update (LU) or Routing Update (RU), and confirms equivalent PLMN information included in a message for accepting the LU or the RU. The equivalent PLMN information includes at least one equivalent PLMN. Each equivalent PLMN has a tag for indicating a valid area.

In step 105, the portable terminal classifies equivalent PLMNs by using tags of the PLMNs included in the equivalent PLMN information, and updates an equivalent PLMN list. That is, the portable terminal adds a PLMN included in the equivalent PLMN information to the equivalent PLMN list, and deletes a PLMN not included in the equivalent PLMN information from the equivalent PLMN list. However, if the equivalent PLMN information is obtained through the LUA process, an equivalent PLMN having a tag value RA is not deleted even if it is not included in the equivalent PLMN information. If the equivalent PLMN information is obtained through the RUA process, an equivalent PLMN having a tag value LA is not deleted even if it is not included in the equivalent PLMN information. In addition, irrespective of the LUA process and the RUA process, an equivalent PLMN having a tag value PLMN is not deleted even if it is not included in the equivalent PLMN information. In other words, if the equivalent PLMN information is obtained through the LUA process, the portable terminal determines an equivalent PLMN to be deleted among the remaining PLMNs other than the equivalent PLMN having the tag value RA. If the equivalent PLMN information is obtained through the RUA process, the portable terminal determines the equivalent PLMN to be deleted among the remaining PLMNs other than the equivalent PLMN having the tag value LA. That is, if there is an equivalent PLMN which has a tag value corresponding to one process for obtaining the equivalent PLMN information and which is included in the equivalent PLMN list and is not included in the equivalent PLMN information, the portable terminal deletes the equivalent PLMN.

If it is determined in step 101 that there is no need to perform the LUA process or the RUA process, the portable terminal determines whether there is a need to perform a PLMN selection process in step 107. For example, the PLMN selection process is performed when the portable terminal is powered on or when a currently registered PLMN cannot be found.

If it is determined in step 107 that there is a need to perform the PLMN selection process, the portable terminal selects a PLMN to be registered from a stored equivalent PLMN list in step 109. That is, when a PLMN list that may be registered is received from a network through signaling for PLMN registration, the portable terminal selects a PLMN according to a priority. When selecting the PLMN, a tag value of the equivalent PLMN is not considered, and thus equivalent PLMNs have the same priority irrespective of the tag value.

If it is determined in step 107 that there is no need to perform the PLMN process, the portable terminal determines whether an area defined by the tag is changed in step 111. In other words, the portable terminal determines whether the area defined by the tag value is changed as the portable terminal moves. In this case, the portable terminal may know a change of a currently registered routing area, a location area, and a PLMN by using a cell IDentifier (ID), an RA code, an LA code, and a PLMN ID which are included in system information broadcast from a Base Station (BS) to a cell to which the portable terminal is accessed.

When the area defined by the tag is changed, the portable terminal deletes at least one equivalent PLMN corresponding to the changed area in step 113. For example, when the location area is changed, the portable terminal deletes an equivalent PLMN having a tag value LA. Further, when the routing area is changed, the portable terminal deletes the equivalent PLMN having a tag value RA. Furthermore, when the PLMN is changed, the portable terminal deletes an equivalent PLMN having a tag value PLMN.

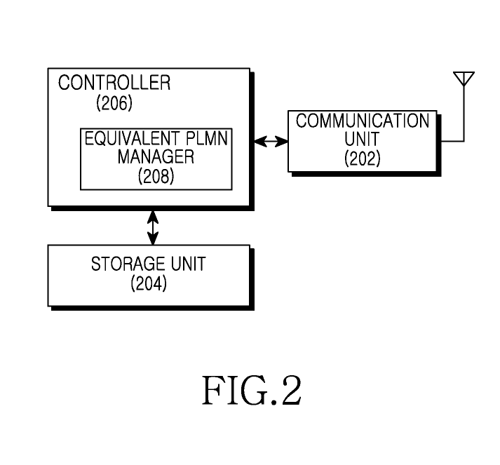

FIG. 2 is a block diagram illustrating a portable terminal according to an exemplary embodiment of the present invention.

Referring to FIG. 2, the portable terminal includes a communication unit 202, a storage unit 204, and a controller 206.

The communication unit 202 provides an interface for transmitting and receiving a signal through a wireless channel. That is, the communication unit 202 converts transmit data into a Radio Frequency (RF) signal and transmits the converted data through an antenna, and also converts the RF signal received through the antenna into receive data. In this case, the communication unit 202 performs conversion between the data and the RF signal according to a communication system protocol.

The storage unit 204 stores a program required for an operation of the portable terminal, a micro code, temporary data, user contents, and the like. More particularly, the storage unit 204 stores an equivalent PLMN list that indicates PLMNs having the same priority. The equivalent PLMN includes a tag which indicates a valid area. Further, the storage unit 204 updates the equivalent PLMN under the control of the controller 206.

The controller 206 provides overall control to the portable terminal. The controller 206 provides transmit data to the communication unit 202, and processes receive data provided from the communication unit 202. Further, the controller 206 provides data to be stored in the storage unit 204, and requests the storage unit 204 to provide the data. Furthermore, the controller 206 selects a PLMN to be registered if necessary. For example, the PLMN selection process is performed when the portable terminal is powered on or when a currently registered PLMN cannot be found. In this case, the controller 206 selects the PLMN to be registered by using an equivalent PLMN list stored in the storage unit 204. That is, when a PLMN list that may be registered is received from a network through signaling for PLMN registration, the controller 206 selects a PLMN according to a priority. When selecting the PLMN, a tag value of the equivalent PLMN is not considered, and thus equivalent PLMNs have the same priority irrespective of the tag value.

More particularly, the controller 206 includes an equivalent PLMN manager 208 for managing an equivalent PLMN list. If an LUA process or an RUA process is performed, the equivalent PLMN manager 208 classifies equivalent PLMNs by using a tag of PLMNs included in equivalent PLMN information received through the LUA process or the RUA process, and updates the equivalent PLMN list. However, if the equivalent PLMN information is obtained through the LUA process, an equivalent PLMN having a tag value RA is not deleted even if it is not included in the equivalent PLMN information, and if the equivalent PLMN information is obtained through the RUA process, an equivalent PLMN having a tag value LA is not deleted even if it is not included in the equivalent PLMN information. In addition, irrespective of the LUA process and the RUA process, an equivalent PLMN having a tag value PLMN is not deleted even if it is not included in the equivalent PLMN information.

When an area defined by a tag value is changed as the portable terminal moves, the equivalent PLMN manager 208 deletes at least one equivalent PLMN corresponding to the changed area. For example, when the location area is changed, the equivalent PLMN manager 208 deletes an equivalent PLMN having a tag value LA. Further, when the routing area is changed, the equivalent PLMN manager 208 deletes the equivalent PLMN having a tag value RA. Furthermore, when the PLMN is changed, the equivalent PLMN manager 208 deletes an equivalent PLMN having a tag value PLMN.

According to exemplary embodiments of the present invention, portable terminals existing in the same area have the same equivalent Public PLMN list, and the equivalent PLMN list can be more effectively managed by using a tag.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for operating a portable terminal, the method comprising:
obtaining equivalent Public Land Mobile Network (PLMN) information from a network;
classifying at least one equivalent PLMN by using a tag of the at least one equivalent PLMN included in the equivalent PLMN information;
adding the at least one equivalent PLMN included in the one equivalent PLMN information to an equivalent PLMN list together with the tag; and
deleting the equivalent PLMN if an equivalent PLMN, which includes a tag value corresponding to a process for obtaining the equivalent PLMN information and which is included in the list and is not included in the equivalent PLMN information, is stored in the equivalent PLMN list.

2. The method of claim 1, further comprising:
when an area defined by the tag value is changed as the portable terminal moves, deleting at least one equivalent PLMN having a tag value corresponding to the changed area from the equivalent PLMN list.

3. The method of claim 2, wherein the tag value is one of a Location Area (LA), a Routing Area (RA), and a PLMN.

4. The method of claim 3, wherein the equivalent PLMN information is obtained by one of a Location Updating-Accept (LUA) process and a Routing Area Update, Accept (RUA) process, and
wherein the deleting of the equivalent PLMN comprises, if the equivalent PLMN information is obtained through the LUA process, determining an equivalent PLMN to be deleted among the remaining PLMNs other than equivalent PLMNs including a tag value RA, and if the equivalent PLMN information is obtained through the RUA process, determining the equivalent PLMN to be deleted among the remaining PLMNs other than equivalent PLMNs including a tag value LA.

5. A portable terminal apparatus, the apparatus comprising:
a controller for obtaining equivalent Public Land Mobile Network (PLMN) information from a network and for classifying at least one equivalent PLMN by using a tag of the at least one equivalent PLMN included in the equivalent PLMN information; and
a storage unit for storing an equivalent PLMN list under the control of the controller,
wherein the controller adds the at least one equivalent PLMN included in the one equivalent PLMN information to an equivalent PLMN list together with the tag, and deletes the equivalent PLMN if an equivalent PLMN, which has a tag value corresponding to a process for obtaining the equivalent PLMN information and which is included in the list and is not included in the equivalent PLMN information, is stored in the equivalent PLMN list.

6. The apparatus of claim 5, wherein, when an area defined by the tag value is changed as the portable terminal moves, the controller deletes at least one equivalent PLMN having a tag value corresponding to the changed area from the equivalent PLMN list.

7. The apparatus of claim 6, wherein the tag value is one of a Location Area (LA), a Routing Area (RA), and a PLMN.

8. The apparatus of claim 7, wherein the equivalent PLMN information is obtained by one of a Location Updating-Accept (LUA) process and a Routing Area Update, Accept (RUA) process, and
wherein, if the equivalent PLMN information is obtained through the LUA process, the controller determines an equivalent PLMN to be deleted among the remaining PLMNs other than equivalent PLMNs including a tag value RA, and if the equivalent PLMN information is obtained through the RUA process, the controller determines the equivalent PLMN to be deleted among the remaining PLMNs other than equivalent PLMNs including a tag value LA.

9. A method for managing equivalent Public Land Mobile Network (PLMN) information in a portable terminal, the method comprising:
obtaining equivalent PLMN information by one of a Location Updating-Accept (LUA) process and a Routing Area Update, Accept (RUA) process;
classifying at least one equivalent PLMN by using a tag of the at least one equivalent PLMN included in the equivalent PLMN information;
adding the at least one equivalent PLMN included in the one equivalent PLMN information to an equivalent PLMN list together with the tag; and
if the equivalent PLMN information is obtained through the LUA process, determining an equivalent PLMN to be deleted among the remaining PLMNs other than equivalent PLMNs including a tag value Routing Area (RA), and if the equivalent PLMN information is obtained through the RUA process, determining the equivalent PLMN to be deleted among the remaining PLMNs other than equivalent PLMNs including a tag value Location Area (LA).

10. The method of claim 9, further comprising:
when an area defined by the tag value is changed as the portable terminal moves, deleting at least one equivalent PLMN having a tag value corresponding to the changed area from the equivalent PLMN list.

11. The method of claim 10, further comprising:
deleting the equivalent PLMN if an equivalent PLMN, which includes the tag value corresponding to a process for obtaining the equivalent PLMN information and which is included in the list and is not included in the equivalent PLMN information, is stored in the equivalent PLMN list.
